(19) United States
(12) Patent Application Publication
(10) Pub. No.: US 2026/0291317 A1
(43) Pub. Date: Sep. 24, 2026

(54) ELECTRIC MACHINE HAVING FILM-LIKE INSULATION MADE OF A THERMOPLASTIC MATERIAL

(71) Applicant: Schaeffler Technologies AG & Co. KG, Herzogenaurach (DE)

(72) Inventors: Dennis Kuhl, Bühl (DE); Stefan Rieß, Kaufering (DE); Ivo Agner, Bühl (DE); Dirk Reimnitz, Bühl (DE); Holger Witt, Bühl (DE)

(73) Assignee: Schaeffler Technologies AG & Co. KG, Herzogenaurach (DE)

(21) Appl. No.: 19/475,632

(22) PCT Filed: Mar. 20, 2024
(86) PCT No.: PCT/DE2024/100236

§ 371 Date: Oct. 15, 2025

(30) Foreign Application Priority Data
Apr. 19, 2023 (DE) 10 2023 109 824.1

(51) Int. Cl. H02K 3/30; H02K 15/121

(52) U.S. Cl. CPC H02K 3/30; H02K 15/121

(57) ABSTRACT

The present disclosure relates to an electric machine having a magnetic-flux-conducting element and a current-flow-conducting element, wherein film-like insulation including a thermoplastic material is applied to the outer contour of the magnetic-flux-conducting element by means of temperature-dependent softening of the thermoplastic material. The present disclosure also relates to a method for producing an aforementioned electric machine, wherein a film made of thermoplastic material is reshaped under the influence of temperature and is applied to the magnetic-flux-conducting element.

### CROSS-REFERENCE TO RELATED APPLICATIONS

This application is the United States National Phase of PCT Appln. No. PCT/DE2024/100236 filed Mar. 20, 2024, which claims priority to German Application No. DE 10 2023 109824.1 filed Apr. 19, 2023, the entire disclosures of which are incorporated by reference herein.

### FIELD OF INVENTION

The invention relates to an electric machine, for example an axial flux machine or a radial flux machine, with a magnetic-flux-conducting element, for example a stator or rotor, and a current-flow-conducting element.

### BACKGROUND

In electric machines, for example, basic insulation is used between the winding and a stator formed as a laminated core. This is intended to prevent housing parts from coming into contact with live parts. Accordingly, basic insulation contributes significantly to keeping people safe. In the prior art, the basic insulation in radial flux machines is traditionally realized by insulation paper. The problem with axial flux machines is that, due to the geometry and the limited radial installation space, the use of insulation paper cannot be directly transferred to the axial flux machine.

### SUMMARY

The object of the present disclosure is to eliminate or at least (partially) alleviate the disadvantages mentioned.

This is achieved in a generic electric machine in that a film-like insulation having a thermoplastic material is applied to the outer contour of the magnetic-flux-conducting element with temperature-dependent softening of the thermoplastic material. The thermoplastic material is applied in such a way that it forms a separate layer on the outer contour of the magnetic-flux-conducting element, in the form of a “thin skin.” The advantage of the thermoplastic material is that its shape adapts to the outer contour of the magnetic-flux-conducting element. This allows for a wrinkle-free and/or crease-free application.

Advantageous embodiments are claimed in the dependent claims and are explained in more detail below.

It is advantageous if the film-like insulation forms a basic insulation. This prevents housing parts from coming into contact with live parts. Accordingly, basic insulation contributes significantly to keeping people safe.

It is advantageous if the magnetic-flux-conducting element is covered on all sides by the thermoplastic material or at least on the upper side or underside and the inner side and outer side by the thermoplastic material. If the thermoplastic material covers the upper side as well as the inner side and outer side, this is designed as a kind of lid, leaving only the underside free. If the underside is also covered with the thermoplastic material, the magnetic-flux-conducting element is completely covered by the thermoplastic material and has no uncovered faces/sides. This ensures complete insulation of the magnetic-flux-conducting element.

Furthermore, the thermoplastic material can be designed as a film. A film has a flexible shape that assists/facilitates application.

In an example embodiment, the film is designed as a PET film. This type of film has the necessary properties to fit as closely as possible to the outer contour of the magnetic-flux-conducting element.

Furthermore, the film can be made up of one or more parts. Depending on the design, in a multi-part film, the film can be connected to itself, for example, to form a completely sealed film-like insulation. For this purpose, the film parts can be connected to each other, for example by welding or gluing. In a one-piece design, the film can be folded over and placed around the magnetic-flux-conducting element to create complete film-like insulation. Various flexible design options are conceivable here.

In addition, an adhesive and/or a baked-on varnish can be applied to the outer contour of the magnetic-flux-conducting element and/or to the film. This leads to an additional strengthening of the film on the magnetic-flux-conducting element, which makes it more difficult to remove the film. Particularly, the adhesive and/or the baked-on varnish can be applied to the upper side, underside, inner side and/or outer side of the magnetic-flux-conducting element.

In an advantageous embodiment, the magnetic flux-conducting element is a stator with a plurality of stator teeth and with stator slots formed between the stator teeth. The film-like insulation is thus adapted to the outer contour of the stator formed by stator teeth and stator slots.

In addition, the film can have different thicknesses in some regions. For example, the film can be made thicker at angular/sharp-edged points to counteract wear.

In addition, the film can be designed in such a way that it has a thickness which varies in some regions before being applied to the outer contour of the magnetic-flux-conducting element and a constant thickness after being applied to the outer contour of the magnetic-flux-conducting element. By varying the thickness of the film in some regions before it is applied to the outer contour of the magnetic-flux-conducting element, it can be ensured that the film is not thinner in predetermined places, such as angular/sharp-edged areas, than in other places after it has been applied to the outer contour of the magnetic-flux-conducting element.

Furthermore, the present disclosure relates to a method for producing an aforementioned electric machine, wherein a film made of thermoplastic material is reshaped under the influence of temperature and is applied/melted directly onto the magnetic-flux-conducting element, which is designed, for example, as a laminated core. The method can have one or more steps. The method may be a reshaping process. In the reshaping process, pressure differences, tools or liquids can be used as aids to form a film-like insulation on the magnetic-flux-conducting element that is as defect-free as possible and to support/simplify the method sequence.

In addition, in the method, the film can be provided in such a way that it has a thickness which varies in some regions before being applied to the outer contour of the magnetic-flux-conducting element and a constant thickness after being applied to the outer contour of the magnetic-flux-conducting element. By varying the thickness of the film in some regions before it is applied to the outer contour of the magnetic-flux-conducting element, it can be ensured that the film is not thinner in predetermined places, such as angular/sharp-edged areas, than in other places after it has been applied to the outer contour of the magnetic-flux-conducting element.

In other words, the present disclosure relates to a stator for an electric machine, having a plurality of stator teeth, each provided as a core for a wound coil, wherein a base insulation having a thermoplastic material is applied to the outer contour of the stator teeth with temperature-dependent softening of the thermoplastic material. The thermoplastic material is applied in such a way that it forms a separate layer on the outer contour of the stator teeth, in the form of a “thin skin.” The advantage of the thermoplastic material is that its shape adapts to the outer contour of the stator teeth. This allows for a wrinkle-free and/or crease-free application.

In other words, the present disclosure relates to a starting film/film made of a thermoplastic material which can be deformed under the influence of temperature and is thereby applied directly to the magnetic-flux-conducting element, for example a stator laminated core. The starting film can have different thicknesses in some regions or have a special shape.

The starting film or the magnetic-flux-conducting element can be coated with an adhesive or baked-on varnish. The reshaping process for applying the starting film can be carried out in one or more steps. Pressure differences, tools or liquids can serve as aids in the reshaping process.

### BRIEF DESCRIPTION OF THE DRAWING

An advantageous embodiment of the present disclosure is explained in more detail below with reference to a drawing with a figure.

In the drawing:

FIG. 1 shows a magnetic-flux-conducting element of an electric machine according to the present disclosure with applied film-like insulation in the form of a thermoplastic material.

The figure is only schematic in nature and serves only for understanding the present disclosure. Identical elements are provided with the same reference signs. Features of the embodiment can be interchanged and used alternatively/cumulatively.

### DETAILED DESCRIPTION

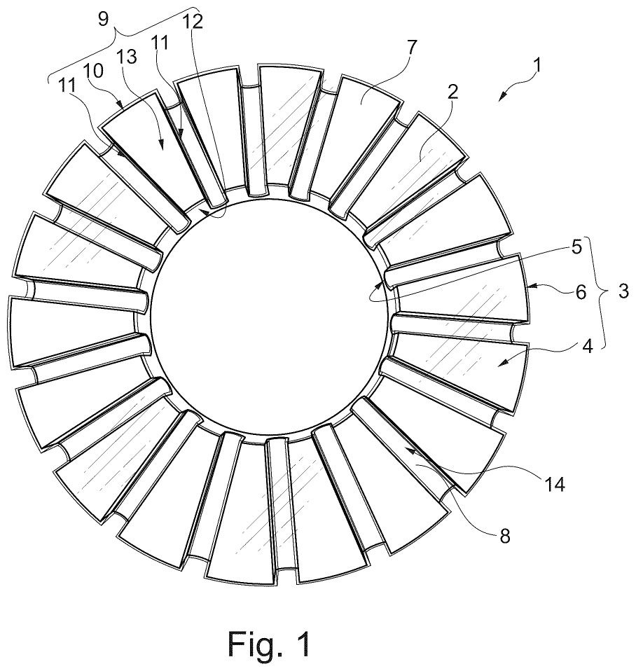

FIG. 1 shows a magnetic-flux-conducting element 1 for an electric machine according to the present disclosure, for example an axial flux machine or a radial flux machine. The electric machine according to the present disclosure also includes a current-flow-conducting element (not shown here). It should be noted that a film-like insulation 2 having a thermoplastic material is applied to the outer contour 3 of the magnetic-flux-conducting element 1 with temperature-dependent softening of the thermoplastic material.

In the illustrated embodiment, the film-like insulation 2 is applied in the form of a film.

The outer contour 3 of the magnetic-flux-conducting element 1 is defined by an upper side 4, an inner side 5, an outer side 6 and an underside (hidden here according to the representation).

The magnetic-flux-conducting element 1 shown in FIG. 1 is designed as a stator. The stator has a plurality of stator teeth 7 and stator slots 8 on a stator yoke, wherein a stator slot 8 is formed between each two stator teeth 7. The stator teeth 7 each has an outer contour 9 which is divided into an outer side 10, side faces 11, an inner side 12 and an upper side 13. The stator slots 8 each has an upper side 14.

The upper side 4 of the magnetic-flux-conducting element 1, in the form of the stator, is formed by the side faces 11 of the stator teeth 7, the upper sides 13 of the stator teeth 7 and the upper sides 14 of the stator slots 8. The inner side 5 is formed by the inner sides 12 of the stator teeth 7 and by the inner side of the rest of the stator, the stator yoke. This also applies to the outer side 6, which is formed from the outer sides 10 of the stator teeth 7 and the outer side of the rest of the stator, the stator yoke.

Thus, the magnetic-flux-conducting element 1 in the form of the stator in the embodiment shown in FIG. 1 is covered with the film-like insulation 2 except for the underside.

### LIST OF REFERENCE SIGNS

1 Magnetic-flux-conducting element
2 Film-like insulation
3 Outer contour
4 Upper side of the stator
5 Inner side of the stator
6 Outer side of the stator
7 Stator tooth
8 Stator slot
9 Outer contour of the stator tooth
10 Outer side of the stator tooth
11 Side face of the stator tooth
12 Inner side of the stator tooth
13 Upper side of the stator tooth
14 Upper side of the stator slot

1. An electric machine comprising a magnetic-flux-conducting element and a current-flow-conducting element, wherein film-like insulation comprising a thermoplastic material is disposed on an outer contour of the magnetic-flux-conducting element by temperature-dependent softening of the thermoplastic material.

2. The electric machine according to claim 1, wherein the film-like insulation forms a basic insulation.

3. The electric machine according to claim 1, wherein the magnetic-flux-conducting element is covered on all sides by the thermoplastic material or is covered at least on an axial upper side, a radial inner side, and a radial outer side by the thermoplastic material.

4. The electric machine according to claims 1, wherein the thermoplastic material is configured as a film.

5. The electric machine according to claim 4, wherein the film is configured as PET film.

6. The electric machine according to claim 4, wherein the film comprises one or more parts.

7. The electric machine according to claim 4, wherein at least one of an adhesive or a baked-on varnish is applied to at least one of the outer contour of the magnetic-flux-conducting element or to the film.

8. The electric machine according to claim 4, wherein the film has different thicknesses in one or more regions.

9. The electric machine according to claim 4, wherein the film is configured in such a way that the film has a thickness that varies in one or more regions before being applied to the outer contour of the magnetic-flux-conducting element and a constant thickness after being applied to the outer contour of the magnetic-flux-conducting element.

10. A method for producing an electric machine according to claim 1, wherein a film made of thermoplastic material is deformed under influence of temperature and is applied to the magnetic-flux-conducting element.

11. The method according to claim 10, wherein the film is provided in such a way that the film has a thickness which varies in one or more regions before being applied to the outer contour of the magnetic-flux-conducting element and a constant thickness after being applied to the outer contour of the magnetic-flux-conducting element.

12. The method according to claim 9, wherein the method has one or more steps.

13. ) A method for producing a magnetic flux-conducting element for an electric machine, the method comprising:
obtaining a magnetic flux-conducting element; and
applying a film-like insulation to an outer contour of the magnetic flux-conducting element, the film-like insulation comprising a thermoplastic material, wherein applying the film-like insulation comprises temperature-dependent softening of the thermoplastic material.

14. The method according to claim 13, wherein applying a film-like insulation covers all sides of the magnetic flux-conducting element by the thermoplastic material or covers at least on an axial upper side, a radial inner side, and a radial outer side by the magnetic flux-conducting element.

15. The method according to claim 13, wherein the thermoplastic material comprises a PET film.

16. The method according to claim 13, further comprising applying at least one of an adhesive or a varnish to an outer contour of the magnetic flux-conducting element.

17. The method according to claim 16, wherein applying the at least one of an adhesive or a varnish comprises applying the varnish, and wherein the varnish applying comprising baking the varnish on the outer contour of the magnetic flux-conducting element.

18. The method according to claim 13, wherein the thermoplastic material comprises a film, and applying the film comprises varying a thickness of the film before applying the film to the outer contour of the magnetic flux-conducting element, wherein the film has a constant thickness after being applied to the outer contour of the magnetic flux-conducting element.
